(19) United States
(12) Patent Application Publication
(10) Pub. No.: US 2024/0388155 A1
(43) Pub. Date: Nov. 21, 2024

(54) COIL SUBSTRATE, MOTOR COIL SUBSTRATE, AND MOTOR

(71) Applicant: IBIDEN CO., LTD., Ogaki (JP)

(72) Inventors: Takahisa HIRASAWA, Ogaki (JP); Takayuki FURUNO, Ogaki (JP)

(73) Assignee: IBIDEN CO., LTD., Ogaki (JP)

(21) Appl. No.: 18/786,655

(22) Filed: Jul. 29, 2024

Related U.S. Application Data
(63) Continuation of application No. PCT/JP2023/002175, filed on Jan. 25, 2023.

(30) Foreign Application Priority Data
Jan. 31, 2022 (JP) 2022-012946

(51) Int. Cl. H02K 3/26

(52) U.S. Cl. CPC H02K 3/26

(57) ABSTRACT

A coil substrate includes a flexible substrate and coils including first wirings and second wirings. The first wirings are formed on a first surface of the substrate. The second wirings are formed on a second surface of the substrate. The flexible substrate has a first end in a longitudinal direction of the substrate and is wound from the first end in a circumferential direction around an axis extending in an orthogonal direction orthogonal to the longitudinal direction such that the substrate is formed into a cylindrical shape, the first surface of the substrate is positioned on an inner circumferential side of the cylindrical shape, and the second surface of the substrate is positioned on an outer circumferential side of the cylindrical shape, and the substrate has a first region adjacent to the first end such that the first region includes the second wirings and does not include the first wirings.

### CROSS-REFERENCE TO RELATED APPLICATIONS

The present application is a continuation of and claims the benefit of priority to International Application No. PCT/JP2023/002175, filed Jan. 25, 2023, which is based upon and claims the benefit of priority to Japanese Application No. 2022-012946, filed Jan. 31, 2022. The entire contents of these applications are incorporated herein by reference.

### BACKGROUND OF THE INVENTION

### Field of the Invention

The present invention relates to a coil substrate, a motor coil substrate formed using the coil substrate, and a motor formed using the motor coil substrate.

### Description of Background Art

Japanese Patent Application Laid-Open Publication No. 2020-182268 describes a coil substrate having a flexible substrate and spiral-shaped wirings formed on both sides of the flexible substrate. The entire contents of this publication are incorporated herein by reference.

### SUMMARY OF THE INVENTION

According to one aspect of the present invention, a coil substrate includes a flexible substrate having a first surface and a second surface on the opposite side with respect to the first surface, and coils including first wirings and second wirings such that the first wirings are formed on the first surface of the flexible substrate and that the second wirings are formed on the second surface of the flexible substrate. The flexible substrate has a first end in a longitudinal direction of the flexible substrate and is wound from the first end in a circumferential direction around an axis extending in an orthogonal direction orthogonal to the longitudinal direction such that the flexible substrate is formed into a cylindrical shape, that the first surface of the flexible substrate is positioned on an inner circumferential side of the cylindrical shape and that the second surface of the flexible substrate is positioned on an outer circumferential side of the cylindrical shape, and the flexible substrate has a first region adjacent to the first end such that the first region includes the second wirings and does not include the first wirings.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a plan view schematically illustrating a coil substrate according to an embodiment of the present invention;

FIG. 2 is a cross-sectional view schematically illustrating a coil substrate according to an embodiment of the present invention;

FIG. 3 is a perspective view schematically illustrating a motor coil substrate according to an embodiment of the present invention;

FIG. 4 is an explanatory cross-sectional view schematically illustrating a portion of a motor coil substrate according to an embodiment of the present invention; and

FIG. 5 is a cross-sectional view schematically illustrating a motor according to an embodiment of the present invention.

### DETAILED DESCRIPTION OF THE EMBODIMENTS

Embodiments will now be described with reference to the accompanying drawings, wherein like reference numerals designate corresponding or identical elements throughout the various drawings.

### Embodiment

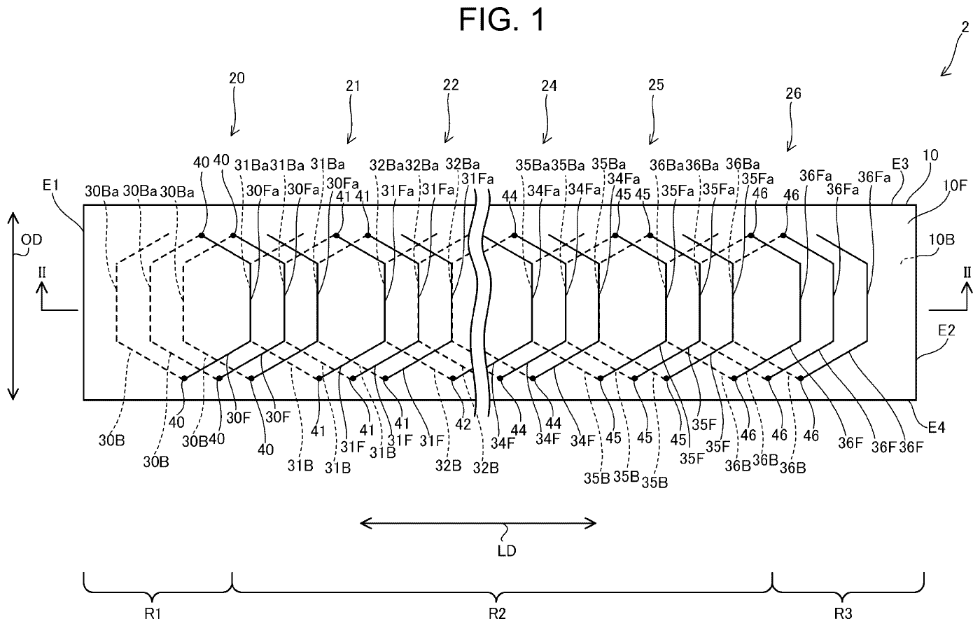

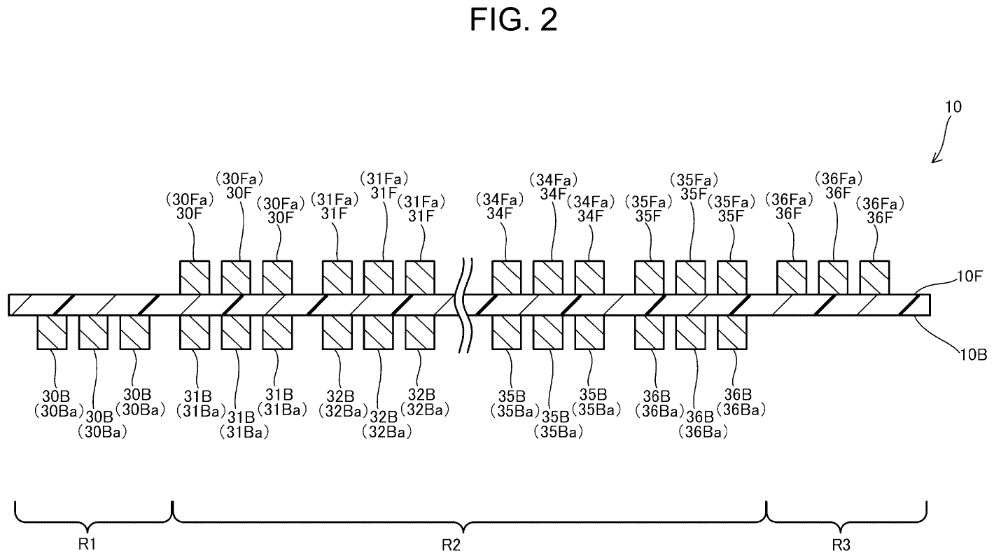

FIG. 1 is a plan view illustrating a coil substrate 2 of an embodiment. FIG. 2 is a cross-sectional view between II-II of FIG. 1. As illustrated in FIG. 1, the coil substrate 2 has a flexible substrate 10 and multiple coils (20, 21, 22, 24, 25, 26). Although FIG. 1 illustrates only the coils (20, 21, 22, 24, 25, 26), the coil substrate 2 also has coils other than the coils (20, 21, 22, 24, 25, 26).

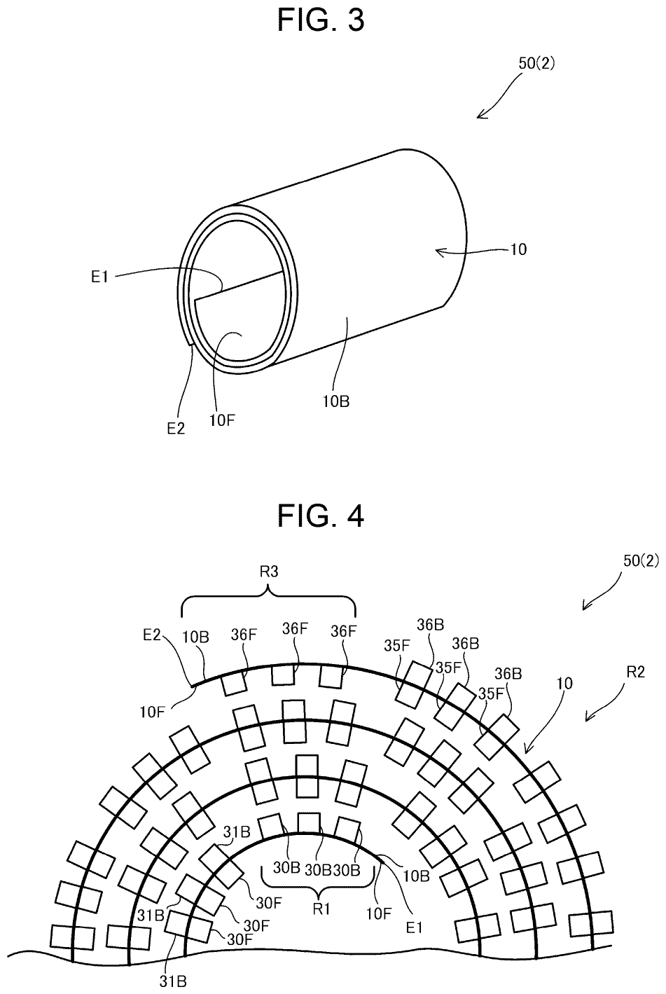

The flexible substrate 10 is a resin substrate having a first surface (10F) and a second surface (10B) on the opposite side with respect to the first surface (10F). The flexible substrate 10 is formed using an insulating resin such as polyimide or polyamide. The flexible substrate 10 is flexible. The flexible substrate 10 is formed in a rectangular shape having four sides, first side (E1)-fourth side (E4). The first side (E1) is a short side on one end side of the flexible substrate 10 in a longitudinal direction (arrow (LD) direction in FIG. 1). The second side (E2) is a short side on the other end side in the longitudinal direction. The first side (E1) and the second side (E2) are short sides extending along an orthogonal direction (arrow (OD) direction in FIG. 1) that is orthogonal to the longitudinal direction. The third side (E3) and the fourth side (E4) are long sides extending in the longitudinal direction. As will be described in detail later, when the coil substrate 2 is wound into a cylindrical shape to form a motor coil substrate 50 (see FIG. 3), the first surface (10F) is positioned on an inner circumferential side and the second surface (10B) is positioned on an outer circumferential side.

In FIGS. 1 and 2, illustration of a middle portion in the longitudinal direction of the flexible substrate 10 is omitted. The flexible substrate 10 has a first region (R1) adjacent to the first side (E1), a second region (R2) next to the first region (R1), and a third region (R3) next to the second region (R2) and adjacent to the second side (E2). The second region (R2) is a region between the first region (R1) and the third region (R3).

The coils (20, 21, 22, 24, 25, 26) are formed to line up along the longitudinal direction of the flexible substrate 10. The coils (20, 21, 22) and the coils (24, 25, 26) may each respectively form a U phase, a V phase, and a W phase of a three-phase motor. The coils (20, 21, 22, 24, 25, 26) are positioned in this order from the first side (E1) to the second side (E2). Other coils (not illustrated) are provided between the coils (20, 21, 22) and the coils (24, 25, 26). The coils are formed by first wirings (see reference numeral symbols “30F,” “31F,” and the like in FIG. 1) provided on the first surface (10F) and second wirings (see reference numeral symbols “30B,” “31B,” and the like) provided on the second surface (10B).

The coil 20 is formed by forming second wirings (30B) on the second surface (10B) side, each forming a half turn of one turn, and first wirings (30F) on the first surface (10F) side, each forming a remaining half turn, with adjacent turns being formed in a staggered manner. In FIG. 1, the coil 20 has wirings for three turns. The first wirings (30F) and second wirings (30B) forming the turns are electrically connected via via conductors 40 penetrating the flexible substrate 10. The first wirings (30F) each have a first orthogonal part (30Fa) extending along the orthogonal direction (see the arrow (OD)). The second wirings (30B) also each have a second orthogonal part (30Ba) extending along the orthogonal direction. The coil 20 is formed extending over the first region (R1) and the second region (R2) of the flexible substrate 10. The second wirings (30B) are formed in the first region (R1). The first wirings (30F) are not formed in the first region (R1). The first wirings (30F) are formed in the second region (R2).

Similarly, the coil 21 is formed by forming second wirings (31B) on the second surface (10B) side, each forming a half turn of one turn, and first wirings (31F) on the first surface (10F) side, each forming a remaining half turn, with adjacent turns being formed in a staggered manner. The coil 21 has wirings for three turns. The first wirings (31F) and second wirings (31B) forming the turns are electrically connected via via conductors 41. The first wirings (31F) each have a first orthogonal part (31Fa) extending along the orthogonal direction (see the arrow (OD)). The second wirings (31B) also each have a second orthogonal part (31Ba) extending along the orthogonal direction. The coil 21 is entirely formed in the second region (R2) of the flexible substrate 10. That is, the first wirings (31F) and second wirings (31B) are formed in the second region (R2).

Similarly, the coil 22 also includes second wirings (32B) and first wirings (not illustrated) for three turns. The second wirings (32B) and the first wirings are connected via via conductors 42. The first wirings each have a first orthogonal part, and the second wirings (32B) each have a second orthogonal part (32Ba). The coil 22 also is entirely formed in the second region (R2) of the flexible substrate 10.

As illustrated in FIGS. 1 and 2, the first orthogonal parts (30Fa) of the first wirings (30F) forming the coil 20 respectively overlap the second orthogonal parts (31Ba) of the second wirings (31B) forming the adjacent coil 21 with the flexible substrate 10 in between. The first orthogonal parts (31Fa) of the first wirings (31F) forming the coil 21 respectively overlap the second orthogonal parts (32Ba) of the second wirings (32B) forming the adjacent coil 22 with the flexible substrate 10 in between.

The coil 24 also includes second wirings (not illustrated) and first wirings (34F) for three turns. The second wirings and the first wirings (34F) are connected via via conductors 44. The first wirings (34F) each have a first orthogonal part (34Fa), and the second wirings each have a second orthogonal part. The coil 24 also is entirely formed in the second region (R2) of the flexible substrate 10.

The coil 25 also includes second wirings (35B) and first wirings (35F) for three turns. The second wirings (35B) and the first wirings (35F) are connected via via conductors 45. The first wirings (35F) each have a first orthogonal part (35Fa), and the second wirings (35B) each have a second orthogonal part (35Ba). The coil 25 also is entirely formed in the second region (R2) of the flexible substrate 10.

The coil 26 also includes second wirings (36B) and first wirings (36F) for three turns. The second wirings (36B) and the first wirings (36F) are connected via via conductors 46. The first wirings (36F) each have a first orthogonal part (36Fa), and the second wirings (36B) each have a second orthogonal part (36Ba). The coil 26 is formed extending over the second region (R2) and the third region (R3) of the flexible substrate 10. The second wirings (36B) are formed in the second region (R2). The first wirings (36F) are formed in the third region (R3). The second wirings (36B) are not formed in the third region (R3).

The first orthogonal parts (34Fa) of the first wirings (34F) forming the coil 24 respectively overlap the second orthogonal parts (35Ba) of the second wirings (35B) forming the adjacent coil 25 with the flexible substrate 10 in between. The first orthogonal parts (35Fa) of the first wirings (35F) forming the coil 25 respectively overlap the second orthogonal parts (36Ba) of the second wirings (36B) forming the adjacent coil 26 with the flexible substrate 10 in between.

The formation in FIGS. 1 and 2 is merely an example. In other modified examples, it is also possible that the first orthogonal parts (30Fa) of the first wirings (30F) forming the coil 20 do not respectively overlap the second orthogonal parts (31Ba) of the second wirings (31B) forming the immediately adjacent coil 21 as long as they respectively overlap the second orthogonal parts of the second wirings forming another coil (for example, the second orthogonal parts of the second wirings of a third adjacent coil). The same applies to the coils (21, 22, 24, 25, 26). When either structure is adopted, it is sufficient that the second wirings (30B, 31B) and the like are formed in the first region (R1) and the first wirings (30F, 31F) and the like are not formed in the first region (R1). It is sufficient that the first wirings (36F, 35F) and the like are formed in the third region (R3) and the second wirings (36B, 35B) and the like are not formed in the third region (R3).

Although not illustrated, the first surface (10F), and the first wirings (30F) and the like are covered with a resin insulation layer. Similarly, the second surface (10B) and the second wirings (30B) and the like are covered with a resin insulation layer.

FIG. 3 is a perspective view schematically illustrating the motor coil substrate 50 formed using the coil substrate 2 of the embodiment (FIGS. 1 and 2). As illustrated in FIG. 3, the motor coil substrate 50 for a motor is formed by winding the coil substrate 2 of the embodiment (FIGS. 1 and 2) into a cylindrical shape. When the coil substrate 2 is wound into a cylindrical shape, the coil substrate 2 is wound multiple turns in a circumferential direction around an axis extending in the orthogonal direction (an axis extending parallel to the first side (E1)) with the first side (E1) (FIG. 1) as a starting point. Further, the number of turns the coil substrate is wound is not particularly limited. In the example in FIG. 3, the coil substrate 2 is wound four turns. When the coil substrate 2 is wound into a cylindrical shape, the first surface (10F) of the flexible substrate 10 is positioned on the inner circumferential side, and the second surface (10B) is positioned on the outer circumferential side.

FIG. 4 is an explanatory cross-sectional view schematically illustrating a part of the motor coil substrate 50 of FIG. 3. As illustrated, in the motor coil substrate 50, the first region (R1) and a portion of the second region (R2) form an innermost circumferential first layer. A portion of the second region (R2) and the third region (R3) form the outermost circumferential fourth layer.

In the first region (R1) adjacent to the starting end when the coil substrate 2 is wound, the first wirings (30F) provided on the first surface (10F) are not formed, and only the second wirings (30B) provided on the second surface (10B) are formed. Therefore, as illustrated in FIG. 4, in the first region (R1) portion of the innermost circumferential first layer, no wirings are formed on the inner circumferential side (first surface (10F) side), and wirings (second wirings (30B)) are formed only on the outer circumferential side (second surface (10B) side). A region where no wirings are formed is not formed on the outer circumferential side of the first layer. Therefore, even when the flexible substrate 10 of the second layer (that is, the second innermost circumferential layer) is wound on an outer side of the first layer, formation of a gap between the first layer and the second layer is suppressed. Therefore, when the coil substrate 2 of the embodiment is wound in the circumferential direction to form the motor coil substrate 50, the motor coil substrate 50 can be formed into a cylindrical shape with a substantially perfect circular cross section. Therefore, occurrence of a short circuit between the wirings is suppressed.

In the third region (R3) adjacent to the terminating end when the coil substrate 2 is wound, only the first wirings (36F) provided on the first surface (10F) are formed, and the second wirings (36B) provided on the second surface (10B) are not formed. Therefore, as illustrated in FIG. 4, in the third region (R3) portion of the outermost circumferential fourth layer, no wirings are formed on the outer circumferential side (second surface (10B) side), and wirings (first wirings (36F)) are formed only on the inner circumferential side (first surface (10F) side). A region where no wirings are formed is not formed on the inner circumferential side of the fourth layer. Therefore, formation of a gap between the third and fourth layers is also suppressed. The motor coil substrate 50 can be formed into a cylindrical shape with a substantially perfect circular cross section.

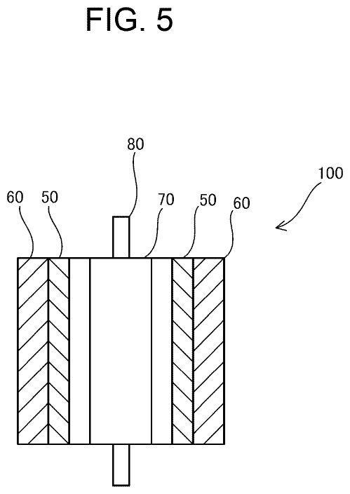

FIG. 5 is a cross-sectional view schematically illustrating a motor 100 formed using the motor coil substrate 50 of the embodiment (FIGS. 3 and 4). The motor 100 is formed by positioning the motor coil substrate 50 on an inner side of a yoke 60 and positioning a rotation shaft 80 and a magnet 70 fixed to the rotation shaft 80 on an inner side of the motor coil substrate 50.

In the above, the structures of the coil substrate 2 (FIGS. 1 and 2), the motor coil substrate 50 (FIGS. 3 and 4), and the motor 100 (FIG. 5) of the embodiment have been described. By using the coil substrate 2 of the embodiment, the motor coil substrate 50 can be formed into a cylindrical shape with a substantially perfect circular cross section. Therefore, when the motor 100 is formed, interference between the magnet 70, which is positioned on the inner side of the motor coil substrate 50, and the motor coil substrate 50 is prevented. Further, since a gap between the motor coil substrate 50 and the yoke 60 becomes constant, high heat dissipation performance is achieved. Therefore, when the motor 100 is formed using the coil substrate 2 of the embodiment, a motor 100 with stable performance can be obtained.

### Modified Example

In a modified example, formation of wirings forming the coils (20, 21, 22, 24, 25, 26) is different from that in the embodiment. Although not illustrated, in the modified example, a first wiring (30F) and a second wiring (30B) that form the coil 20 are each formed in a spiral shape (hexagonal spiral shape). The first wiring (30F) and the second wiring (30B) are connected via a via conductor. The first wiring (30F) and the second wiring (30B) are formed in an offset manner. The coils (21, 22, 24, 25, 26) and the like also each have a similar structure.

Also in the modified example, the second wirings (wirings on the second surface (10B) side) are formed in the first region (R1), and no first wirings (wirings on the first surface (10F) side) are formed in the first region (R1). The first wirings are formed in the third region (R3), and no second wirings are formed in the third region (R3).

Therefore, when the coil substrate 2 of the modified example is wound to form the motor coil substrate 50, similar to that in the embodiment, in the first region (R1) portion of the first layer, no wirings are formed on the inner circumferential side (first surface (10F) side), and wirings (second wirings) are formed only on the outer circumferential side (second surface (10B) side). A region where no wirings are formed is not formed on the outer circumferential side of the first layer. Therefore, even when the flexible substrate 10 of the second layer is wound on an outer side of the first layer, formation of a gap between the first layer and the second layer is suppressed. Further, in the third region (R3) portion of the outermost circumferential fourth layer, no wirings are formed on the outer circumferential side (second surface (10B) side), and wirings (first wirings) are formed only on the inner circumferential side (first surface (10F) side). A region where no wirings are formed is not formed on the inner circumferential side of the fourth layer. Therefore, formation of a gap between the third and fourth layers is also suppressed. The motor coil substrate 50 can be formed into a cylindrical shape with a substantially perfect circular cross section.

Japanese Patent Application Laid-Open Publication No. 2020-182268 describes a coil substrate having a flexible substrate and spiral-shaped wirings formed on both sides of the flexible substrate. A motor coil substrate is formed by winding the coil substrate into a cylindrical shape. The coil substrate is wound multiple times in a circumferential direction around an axis extending in an orthogonal direction (width direction) orthogonal to a longitudinal direction of the flexible substrate with a side on one end side in the longitudinal direction as a starting end. A first surface of the flexible substrate is positioned on an inner circumferential side, and a second surface on the opposite side with respect to the first surface is positioned on an outer circumferential side.

In a coil of a substrate coil, a first wiring forming a half turn of one turn may be formed on the first surface of the flexible substrate, and a second wiring forming the remaining half turn may be formed on the second surface. In that case, the first wiring is formed adjacent to the starting end on the first surface of the flexible substrate, while no wiring is formed near the starting end on the second surface. Therefore, when the coil substrate is wound into a cylindrical shape with the first surface facing the inner circumferential side using the starting end as a starting point, it is thought that in the innermost circumferential first layer, a wiring is formed on the inner circumferential side (first surface side), but no wiring is formed on the outer circumferential side (second surface side). In that case, the flexible substrate of the second layer (that is, the second layer from the inner circumference) on an outer side of the first layer is wound on an outer side of a region where no wiring is formed on the outer circumferential side of the first layer. As a result, it is thought that a gap is formed between the first layer and the second layer.

When a gap exists on an inner side of the motor coil substrate, it is thought that the motor coil substrate is formed into a polygonal cylindrical shape with a polygonal cross section instead of a cylindrical shape with a circular cross section. As a result, a short circuit may occur between wirings. When a motor is formed by positioning the motor coil substrate, a magnet, and a yoke in a casing, it is thought that it interferes with the magnet positioned on an inner side. Further, it is thought that, since a gap between the motor coil substrate and the yoke is increased, heat dissipation performance deteriorates and stable motor performance cannot be achieved.

A coil substrate according to an embodiment of the present invention includes: a flexible substrate that has a first surface and a second surface on the opposite side with respect to the first surface; and multiple coils that are formed by first wirings provided on the first surface and second wirings provided on the second surface. The coil substrate can be formed into a cylindrical shape with the first surface positioned on an inner circumferential side and the second surface positioned on an outer circumferential side by being wound in a circumferential direction around an axis extending in an orthogonal direction orthogonal to a longitudinal direction of the flexible substrate with a first end in the longitudinal direction as a starting point, The flexible substrate has a first region adjacent to the first end, and a second region adjacent to the first region. The second wirings are formed in the first region, and the first wirings are not formed in the first region.

When a coil substrate according to an embodiment of the present invention is wound in the circumferential direction with the first end as the starting point and is formed into a cylindrical shape, the first region forms the innermost circumferential first layer. In the first region, no first wirings are formed on the first surface, while the second wirings are formed on the second surface. Therefore, when the coil substrate is formed into a cylindrical shape, in the innermost circumferential first layer (first region), no wirings (first wirings) are formed on the inner circumferential side (first surface side), and wirings (second wirings) are formed only on the outer circumferential side (second surface side). A region where no wirings are formed is not formed on the outer circumferential side (second surface side) of the first layer. Therefore, even when the flexible substrate of the second layer (that is, the second innermost circumferential layer) is wound on an outer side of the first layer, formation of a gap between the first layer and the second layer is suppressed. Further, when a coil substrate according to an embodiment of the present invention is wound in the circumferential direction to form a motor coil substrate, the motor coil substrate can be formed into a cylindrical shape with a substantially perfect circular cross section. As a result, occurrence of a short circuit between the wirings is suppressed. When a motor is formed by positioning the motor coil substrate, a magnet, and a yoke in a casing, interference between the magnet, which is positioned on an inner side of the motor coil substrate, and the motor coil substrate is prevented. Further, since a gap between the motor coil substrate and the yoke becomes constant, high heat dissipation performance is achieved. As a result, when a motor is formed using a coil substrate according to an embodiment of the present invention, a motor with stable performance can be obtained.

In a coil substrate according to an embodiment of the present invention, the flexible substrate may further have a third region adjacent to the second region and adjacent to a second end on the opposite side with respect to the first end. The first wirings may be formed in the third region. The second wirings may not be formed in the third region.

In a coil substrate according to an embodiment of the present invention, the multiple coils may each include the first wirings of half turns formed on the first surface, the second wirings of half turns formed on the second surface, and via conductors connecting the first wirings and the second wirings.

A motor coil substrate according to an embodiment of the present invention is formed by winding a coil substrate according to an embodiment of the present invention into a cylindrical shape. The coil substrate is wound around the axis with the first end as the starting point, with the first surface positioned on the inner circumferential side and the second surface positioned on the outer circumferential side.

A motor coil substrate according to an embodiment of the present invention can be formed to have a substantially perfect circular cross section. When a motor is formed, interference between a magnet and the motor coil substrate is prevented. High heat dissipation performance is achieved. Therefore, when a motor is formed using a motor coil substrate according to an embodiment of the present invention, a motor with stable performance can be obtained.

A motor according to an embodiment of the present invention is formed by positioning a motor coil substrate according to an embodiment of the present invention on an inner side of a cylindrical yoke and positioning a rotation shaft and a magnet on an inner side of the motor coil substrate.

In a motor according to an embodiment of the present invention, interference between the magnet and the motor coil substrate is prevented. Further, since a gap between the motor coil substrate and the yoke also becomes constant, high heat dissipation performance is achieved. A motor with stable performance can be obtained.

Obviously, numerous modifications and variations of the present invention are possible in light of the above teachings. It is therefore to be understood that within the scope of the appended claims, the invention may be practiced otherwise than as specifically described herein.

1. A coil substrate, comprising:
a flexible substrate having a first surface and a second surface on an opposite side with respect to the first surface; and
a plurality of coils comprising a plurality of first wirings and a plurality of second wirings such that the plurality of first wirings is formed on the first surface of the flexible substrate and that the plurality of second wirings is formed on the second surface of the flexible substrate,
wherein the flexible substrate has a first end in a longitudinal direction of the flexible substrate and is configured to be wound from the first end in a circumferential direction around an axis extending in an orthogonal direction orthogonal to the longitudinal direction such that the flexible substrate is formed into a cylindrical shape, that the first surface of the flexible substrate is positioned on an inner circumferential side of the cylindrical shape and that the second surface of the flexible substrate is positioned on an outer circumferential side of the cylindrical shape, and the flexible substrate has a first region adjacent to the first end such that the first region includes the second wirings and does not include the first wirings.

2. The coil substrate according to claim 1, wherein the flexible substrate has a second region adjacent to the first region and a third region adjacent to the second region and adjacent to a second end of the flexible substrate on an opposite side with respect to the first end such that the third region includes the first wirings and does not include the second wirings.

3. The coil substrate according to claim 1, wherein each of the coils includes a plurality of half turns comprising the first wirings formed on the first surface, a plurality of half turns comprising the second wirings formed on the second surface, and a plurality of via conductors connecting the first wirings and the second wirings.

4. A motor coil substrate, comprising:
the coil substrate of claim 1 wound from the first end in the circumferential direction around the axis such that the first surface is positioned on the inner circumferential side of the cylindrical shape and that the second surface is positioned on the outer circumferential side of the cylindrical shape.

5. A motor, comprising:
a cylindrical yoke;
the motor coil substrate of claim 4 positioned on an inner side of the cylindrical yoke;
a magnet positioned on the inner side of the cylindrical yoke such that the magnet is positioned on an inner side of the motor coil substrate; and
a rotation shaft positioned on the inner side of the motor coil substrate such that the rotation shaft is on an inner side of the motor coil substrate.

6. The coil substrate according to claim 2, wherein each of the coils includes a plurality of half turns comprising the first wirings formed on the first surface, a plurality of half turns comprising the second wirings formed on the second surface, and a plurality of via conductors connecting the first wirings and the second wirings.

7. A motor coil substrate, comprising:
the coil substrate of claim 2 wound from the first end in the circumferential direction around the axis such that the first surface is positioned on the inner circumferential side of the cylindrical shape and that the second surface is positioned on the outer circumferential side of the cylindrical shape.

8. A motor, comprising:
a cylindrical yoke;
the motor coil substrate of claim 7 positioned on an inner side of the cylindrical yoke;
a magnet positioned on the inner side of the cylindrical yoke such that the magnet is positioned on an inner side of the motor coil substrate; and
a rotation shaft positioned on the inner side of the motor coil substrate such that the rotation shaft is on an inner side of the motor coil substrate.

9. A motor coil substrate, comprising:
the coil substrate of claim 4 wound from the first end in the circumferential direction around the axis such that the first surface is positioned on the inner circumferential side of the cylindrical shape and that the second surface is positioned on the outer circumferential side of the cylindrical shape.

10. A motor, comprising:
a cylindrical yoke;
the motor coil substrate of claim 9 positioned on an inner side of the cylindrical yoke;
a magnet positioned on the inner side of the cylindrical yoke such that the magnet is positioned on an inner side of the motor coil substrate; and
a rotation shaft positioned on the inner side of the motor coil substrate such that the rotation shaft is on an inner side of the motor coil substrate.

11. The coil substrate according to claim 1, wherein the plurality of coils is formed such that the coils are lined up along the longitudinal direction of the flexible substrate.

12. The coil substrate according to claim 11, wherein the flexible substrate has a second region adjacent to the first region and a third region adjacent to the second region and adjacent to a second end of the flexible substrate on an opposite side with respect to the first end such that the third region includes the first wirings and does not include the second wirings.

13. The coil substrate according to claim 11, wherein each of the coils includes a plurality of half turns comprising the first wirings formed on the first surface, a plurality of half turns comprising the second wirings formed on the second surface, and a plurality of via conductors connecting the first wirings and the second wirings.

14. A motor coil substrate, comprising:
the coil substrate of claim 11 wound from the first end in the circumferential direction around the axis such that the first surface is positioned on the inner circumferential side of the cylindrical shape and that the second surface is positioned on the outer circumferential side of the cylindrical shape.

15. A motor, comprising:
a cylindrical yoke;
the motor coil substrate of claim 14 positioned on an inner side of the cylindrical yoke;
a magnet positioned on the inner side of the cylindrical yoke such that the magnet is positioned on an inner side of the motor coil substrate; and
a rotation shaft positioned on the inner side of the motor coil substrate such that the rotation shaft is on an inner side of the motor coil substrate.

16. The coil substrate according to claim 1, wherein the plurality of coils includes a U phase coil, a V phase coil, and a W phase coil and is formed such that the coils are lined up along the longitudinal direction of the flexible substrate.

17. The coil substrate according to claim 16, wherein the flexible substrate has a second region adjacent to the first region and a third region adjacent to the second region and adjacent to a second end of the flexible substrate on an opposite side with respect to the first end such that the third region includes the first wirings and does not include the second wirings.

18. The coil substrate according to claim 16, wherein each of the coils includes a plurality of half turns comprising the first wirings formed on the first surface, a plurality of half turns comprising the second wirings formed on the second surface, and a plurality of via conductors connecting the first wirings and the second wirings.

19. A motor coil substrate, comprising:
the coil substrate of claim 16 wound from the first end in the circumferential direction around the axis such that the first surface is positioned on the inner circumferential side of the cylindrical shape and that the second surface is positioned on the outer circumferential side of the cylindrical shape.

20. A motor, comprising:
a cylindrical yoke;
the motor coil substrate of claim 19 positioned on an inner side of the cylindrical yoke;
a magnet positioned on the inner side of the cylindrical yoke such that the magnet is positioned on an inner side of the motor coil substrate; and
a rotation shaft positioned on the inner side of the motor coil substrate such that the rotation shaft is on an inner side of the motor coil substrate.
